(19) United States
(12) Patent Application Publication
(10) Pub. No.: US 2024/0017345 A1
(43) Pub. Date: Jan. 18, 2024

(54) METHOD FOR JOINING DIFFERENT KINDS OF METAL MATERIALS

(71) Applicant: TOYOTA JIDOSHA KABUSHIKI KAISHA, Toyota-shi, Aichi-ken (JP)

(72) Inventors: Shuhei OGURA, Nagakute-shi (JP); Tomohiko SEKIGUCHI, Nagakute-shi (JP); Shotaro KUROKAWA, Togo-cho (JP); Katsuhiro NAGASAWA, Kariya-shi (JP); Hiroshi ADACHI, Kariya-shi (JP); Daisuke YANAGIBASHI, Kariya-shi (JP); Makoto AOYAMA, Kariya-shi (JP); Keiichirou INAGAKI, Kariya-shi (JP)

(73) Assignee: TOYOTA JIDOSHA KABUSHIKI KAISHA, Toyota-shi, Aichi-ken (JP)

(21) Appl. No.: 18/273,074

(22) PCT Filed: Feb. 22, 2022
(86) PCT No.: PCT/JP2022/007173

§ 371 Date: Jul. 19, 2023

(30) Foreign Application Priority Data
Feb. 26, 2021 (JP) 2021-029903

(51) Int. Cl. B23K 11/20; B23K 11/11; B23K 35/30; B23K 11/00

(52) U.S. Cl. CPC B23K 11/20; B23K 11/115; B23K 35/302; B23K 11/0066; B23K 2103/18

(57) ABSTRACT

A method for joining different kinds of metal materials includes: preparing a rivet, a plurality of metal members, and a first electrode and a second electrode, each having shanks and electrode portions provided at the tips of the shanks; sandwiching the rivet and the plurality of metal members between a first electrode and a second electrode; and embedding the rivet into the metal member by pressurization and energization using the first electrode and the second electrode. The preparation step includes preparing, as the first electrode and the second electrode, two electrodes that satisfy a condition in which each of electrical resistance values of the first and second electrodes is lower than or equal to a sum of an electrical resistance value of the plurality of metal members to be joined and an electrical resistance value of the rivet.

### FIELD

The present disclosure relates to a method for joining different kinds of metal materials, in which a plurality of metal members made of different materials are joined by resistance welding using a rivet.

### RELATED ART

Conventionally, there is a known resistance welding method for joining different kinds of metal materials through resistance welding using a metal rivet having a head and a shaft, as described in Patent Literature 1, for example. In such a resistance welding method, for example, the rivet, an aluminum plate, and an iron plate are sandwiched between two electrodes such that the head, the shaft, the aluminum plate, and the iron plate are arranged in this order. These are pressurized and energized to form a nugget between the shaft having penetrated the aluminum plate and the iron plate, with the aluminum plate being sandwiched between the head and the iron plate, whereby the aluminum plate and the iron plate are joined together. The electrode has an electrode portion and a shank that transmits electricity to the electrode portion and holds the electrode portion.

### Citation List

### Patent Literature

Patent Literature 1: Japanese Patent Application Publication No. 2020-69499

### SUMMARY

When joining different kinds of metal materials using the rivet as described above, high current is required during pressurization and energization to melt aluminum and cause the rivet to quickly penetrate the aluminum plate. However, if the electrical resistance of the electrodes is high, the rating value of the transformer is exceeded, which causes a problem that high current is not allowed to flow.

The present disclosure can be realized by having the following aspects.

According to one aspect of the present disclosure, a method for joining different kinds of metal materials is provided. The method for joining different kinds of metal materials is a method in which a plurality of metal members made of different materials are joined by resistance welding using a rivet, the method including: preparing the rivet, the plurality of metal members, and shanks and electrode portions provided at the tips of the shanks; sandwiching the rivet and the plurality of metal members between the first electrode and the second electrode; and embedding the rivet into the metal member by pressurization and energization using the first electrode and the second electrode, wherein the preparing includes preparing, as the first electrode and the second electrode, two electrodes that satisfy a condition in which each of electrical resistance values of the first and second electrodes is lower than or equal to a sum of an electrical resistance value of the plurality of metal members to be joined and an electrical resistance value of the rivet.

### BRIEF DESCRIPTION OF THE DRAWINGS

FIG. 1 is a process diagram illustrating a method for joining different kinds of metal materials as a first embodiment of the present disclosure.

FIG. 2 is a cross-sectional view schematically illustrating the implementing situation of a sandwiching step.

FIG. 3 is a diagram schematically explaining an example of an energization pattern in the method for joining different kinds of metal materials.

### DETAILED DESCRIPTION

A. First Embodiment:

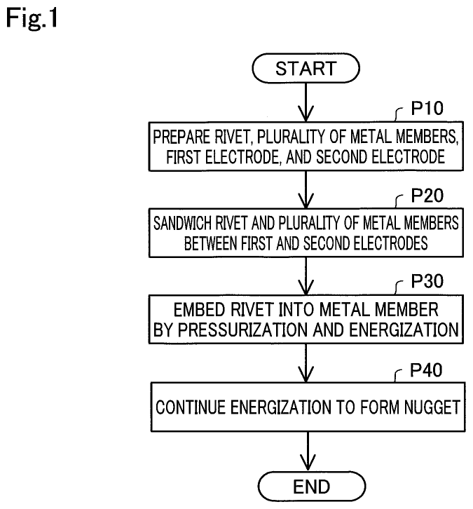

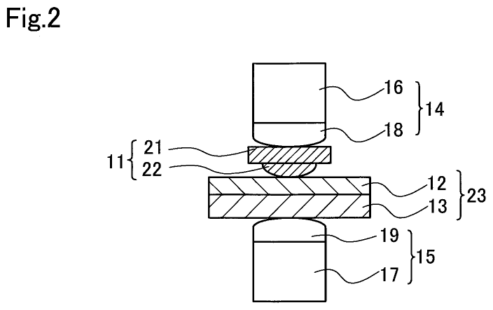

A method for joining different kinds of metal materials in a first embodiment of the present disclosure will be described with reference to FIGS. 1 to 3. FIG. 1 is a process diagram illustrating the method for joining different kinds of metal materials as the first embodiment of the present disclosure. FIG. 2 is a cross-sectional view schematically illustrating the implementing situation of a sandwiching step to be mentioned later. FIG. 2 illustrates the cross-section passing through the central axis of each member. In the method for joining different kinds of metal materials according to the first embodiment, a plurality of (two in this embodiment) metal members made of different materials are joined using a rivet 11 by resistance welding. In this embodiment, an iron plate 13 and an aluminum plate 12 are joined together as the plurality of metal members.

The method for joining different kinds of metal materials includes a preparation step P10, a sandwiching step P20, and an embedding step P30, as illustrated in FIG. 1. Hereinafter, each step will be described in sequence. First, in the preparation step P10, the rivet 11, the aluminum plate 12, the iron plate 13, a first electrode 14, and a second electrode 15 are prepared. The first electrode 14 and the second electrode 15 are a pair of electrodes provided in a well-known resistance spot welding machine (not shown). The resistance spot welding machine is made up of a pressurizing and energizing section, a power supply section, a power control section, and cables for connection, etc., all of which are not shown in the figure.

The first electrode 14 has a first shank 16 and a first electrode portion 18. The second electrode 15 has a second shank 17 and a second electrode portion 19. In the respective electrodes 14 and 15, the electrode portions 18 and 19, which face the metal plates 12 and 13 to be joined, respectively, have a truncated conical shape. The electrode portion 18 has its diameter gradually decreasing from the shank 16 toward its tip. The electrode portion 19 has its diameter gradually decreasing from the shank 17 toward its tip. The tip surface may be a plane or a curved surface with a radius R. The shanks 16 and 17 transmit electricity to the electrode portions 18 and 19 and hold the electrode portions 18 and 19, respectively.

The electrodes 14 and 15 are formed of a copper alloy containing chromium (hereinafter referred to as “Cr copper”). That is, each of the shanks 16 and 17 and each of the electrode portions 18 and 19 are both made of Cr copper. Each of the electrodes 14 and 15 may be of an “integral type” in which the shank 16 or 17 and the electrode portion 18 or 19 are integral with each other or a “cap type” in which the electrode portion 18 or 19 can be replaced.

The rivet 11 is made of iron and has a head 21 and a shaft 22. The head 21 has a disk shape. The shaft 22 is formed to have a substantially cylindrical shape and protrudes from the center of the head 21 toward one side. The shaft 22 has its diameter gradually decreasing toward the tip of the protruding side.

Next, the electrical resistance value will be described. In this embodiment, an electrical resistance value R1 of the first electrode 14 and an electrical resistance value R2 of the second electrode 15 are both approximately 0.1 mΩ The electrical resistance value R1 of the electrode 14 is the sum of an electrical resistance value of the shank 16 and an electrical resistance value of the electrode portion 18. The electrical resistance value R2 of the electrode 15 is the sum of an electrical resistance value of the shank 17 and an electrical resistance value of the electrode portion 19. An electrical resistance value R3 of the rivet 11 is approximately 0.15 mΩ. An electrical resistance value R4 of a laminated body 23 to be welded, which is a stacked structure of the aluminum plate 12 and the iron plate 13, is approximately 0.08 mΩ.

The electrical resistance value is measured, for example, by a well-known resistance measuring instrument (not shown). The electrical resistance value R4 of the laminated body 23 to be welded is measured by causing one terminal and the other terminal included in the resistance measuring instrument to contact the laminated body 23 such that the positions of these terminals are aligned in the energization direction. The electrical resistance value R3 of the rivet 11 is measured by causing one terminal of the resistance measuring instrument to contact a portion of the rivet 11 that is to contact the electrode portion 18 and also by causing the other terminal to contact another portion of the rivet 11 that is to contact the aluminum plate 12.

In this embodiment, each of the electrical resistance values R1 and R2 of the electrodes 14 and 15 is lower than or equal to the sum of the electrical resistance value R3 of the rivet 11 and the electrical resistance value R4 of the laminated body 23 to be welded. In other words, the relationships given by Equations (i) and (ii) below are satisfied. That is, in the preparation step P10, in a situation where the electrical resistance value R3 of the rivet 11 and the electrical resistance value R4 of the laminated body 23 to be welded are known in advance, two electrodes that satisfy the following Equations (i) and (ii) are prepared as the respective electrodes 14 and 15.

R1≤R3+R4 Equation (i)

R2≤R3+R4 Equation (ii)

In the sandwiching step P20 executed after the preparation step P10, as illustrated in FIG. 2, each member is disposed such that the head 21, the shaft 22, the aluminum plate 12, and the iron plate 13 are arranged in this order. In other words, the rivet 11, the aluminum plate 12, and the iron plate 13 are sandwiched between the first electrode 14 and the second electrode 15 in a state where the shaft 22 of the rivet 11 contacts the aluminum plate 12 stacked on the iron plate 13 such that the shaft 22 is orthogonal to the aluminum plate 12. At this time, the first electrode portion 18 is caused to contact the head 21 side of the rivet 11, while the second electrode portion 19 is caused to contact the iron plate 13 side thereof.

In the embedding step P30 executed after the sandwiching step P20, the rivet 11, the aluminum plate 12, and the iron plate 13 are pressurized and energized to embed the shaft 22 of the rivet 11 into the aluminum plate 12. More specifically, the rivet 11, the aluminum plate 12, and the iron plate 13 are pressurized and energized by applying a pressurizing force to the head 21 of the rivet 11 and the iron plate 13 with the first electrode 14 and the second electrode 15 being brought into close proximity with each other, and also by applying the current between the respective electrodes 14 and 15. While the aluminum plate 12 is being melted with the Joule heat generated, the shaft 22 is caused to penetrate the aluminum plate 12.

Then, in a nugget forming step P40 after the embedding step P30, energization is continued to form a nugget between the penetrating shaft 22 and the iron plate 13, with the aluminum plate 12 being sandwiched between the head 21 and the iron plate 13, whereby the aluminum plate 12 and the iron plate 13 are joined together.

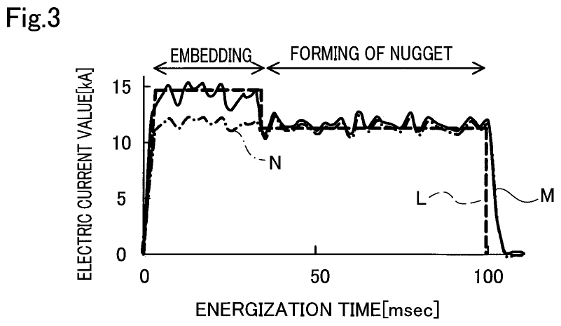

FIG. 3 is a diagram schematically explaining an example of an energization pattern in this embodiment. In FIG. 3, a commanded current value during energization is indicated by a dashed line L, an actual measured value of the actually flowing current is indicated by a solid line M, and a measured value of the current in a comparative aspect is indicated by a single-dotted line N. As indicated by the dashed line L in FIG. 2, a higher current value is required during the embedding step P30 than during the nugget formation. This is because a larger current is required than during the nugget formation executed after the shaft 22 has penetrated the aluminum plate 12 in order to melt the aluminum plate 12 more aggressively to cause the shaft 22 to penetrate the aluminum plate 12.

In the above joining method, when joining n metal members (n is an integer of 2 or more), a metal member located closest to the first electrode 14 side is defined as a first metal member, and the following metal members, which are disposed in layers toward the second electrode 15 side, are defined as a second metal member, . . . , and an nth metal member in order. In the embedding step P30, the shaft 22 is caused to penetrate from the first metal member to the n-1th metal member. The nugget is then formed between the shaft 22 and the nth metal member.

(1) In the preparation step P10 in the method for joining different kinds of metal materials of the first embodiment above, two electrodes are prepared as the first electrode 14 and the second electrode 15 that satisfy the condition in which each of the electrical resistance values R1 and R2 of the first and second electrodes 14 and 15 is lower than or equal to the sum of the electrical resistance value R3 of the rivet 11 and the electrical resistance value R4 of the laminated body 23 to be welded.

During resistance welding, the relationship between voltage V and current I of the resistance spot welding machine is expressed by Equation (iii) below using each electrical resistance value.

V=I×(R1+R2+R3+R4) Equation (iii)

As shown in Equations (i) and (ii) described above, in this embodiment, the electrical resistance value (R1+R2+R3+R4) of the entire configuration for joining the rivet 11, aluminum plate 12, and iron plate 13 in addition to the first and second electrodes 14 and 15, i.e., the resistance spot welding machine, can be reduced by restricting the electrical resistance values R1 and R2 of the first and second electrodes 14 and 15 to lower levels.

Thus, the amount of current flowing through the resistance spot welding machine can be increased even at the same voltage, thus enabling a specified high current to pass during pressurization and energization at the time of resistance welding without replacing the transformer included in the resistance spot welding machine with a large-capacity one.

In particular, as indicated by the solid line M in FIG. 3, the current according to the commanded current value is allowed to flow in a high current range where the commanded current value is 10 kA to 15 kA in the embedding step P30. Furthermore, in the embedding step P30, the shaft 22 can surely penetrate the aluminum plate 12 to reach the iron plate 13, so that the two metal members 12 and 13 can be joined together with a strong joint strength.

(2) For example, the electrical resistivity of a copper alloy containing beryllium (hereinafter referred to as “Be copper”) is approximately six times greater than that of Cr copper. If first and second electrodes in a comparative aspect are formed with the same shape and size as the electrodes 14 and 15 in the first embodiment, but using a different material from that in the first embodiment, i.e., Be copper, it is relatively difficult to satisfy the conditions of relational Equations (i) and (ii) mentioned above. Thus, in the comparative form, the command current value cannot be taken in the embedding step P30, as indicated by the single-dotted line N in FIG. 3.

However, in the method for joining different kinds of metal materials of the above first embodiment, by using Cr copper as the material for the first and second electrodes 14 and 15, the electrical resistance values R1 and R2 of the first and second electrodes 14 and 15 can be restricted to lower levels to satisfy the conditions of Equations (i) and (ii) mentioned above. Thus, as indicated by the solid line M in FIG. 3, the commanded current value can be almost achieved during the embedding step P30.

For this reason, there is no need to increase the diameters of the shanks 16 and 17 and rivet 11 in order to reduce the resistance value of the entire configuration for joining, which can form a preferred embodiment without any problems such as an increase in the size of equipment or interference with peripheral equipment.

B. Other Embodiments:

(B1) In the method for joining different kinds of metal materials of the above embodiment, the material of each electrode is Cr copper, but it may be any other material as long as the conditions of relational Equations (i) and (ii) mentioned above are satisfied. For example, when a material with a high electrical resistivity is used for the electrodes, the electrical resistance value of the entire configuration may be the same or lower than that of the above embodiment by increasing the diameters of the shanks 16 and 17 and the rivet 11. The first electrode 14 and the second electrode 15 may be made of different materials from each other.

(B2) In the method for joining different kinds of metal materials of the above embodiment, the aluminum plate 12 and the iron plate 13 are described as being joined together, but the above method for joining different kinds of metal materials may be applied to the joining of other metal members of different materials. Regarding the number of metal members, three or more plural metal members may also be joined. In this case, at least metal members of different materials from each other are included.

(B3) In the above method for joining different kinds of metal materials of the above embodiment, both the rivet 11 and the metal member on the second electrode 15 side are made of iron, but the rivet 11 and the metal member on the second electrode 15 side may not be made of the same material. The material and shape of the rivet 11 can also be changed as appropriate.

(B4) In the method for joining different kinds of metal materials of the above embodiment, the molten aluminum may be pressurized and energized while being blown off with air.

(B5) The electrical resistance value, current value, and the like in the above-described method for joining different kinds of metal materials of the above embodiment are illustrative only and can be changed as appropriate depending on the size and shape of each member. For example, the current value of energization may be in the range of 5 kA to 30 kA.

The present disclosure is not limited to each of the above embodiments, and various modifications can be made to them to form various configurations without departing from the spirit of the present disclosure. For example, the technical features in each embodiment corresponding to the technical features in each aspect described in the paragraph of the “Summary” of the disclosure can be replaced or combined as appropriate so as to solve some or all of the above problems or to achieve some or all of the above effects. Also, if the technical feature is not described as essential in the present specification, it can be deleted as appropriate. For example, the present disclosure may also be realized by embodiments described below.

[1] According to one embodiment of the present disclosure, a method for joining different kinds of metal materials is provided. The method for joining different kinds of metal materials is a method in which a plurality of metal members made of different materials are joined by resistance welding using a rivet, the method including: preparing the rivet, the plurality of metal members, and shanks and electrode portions provided at the tips of the shanks; sandwiching the rivet and the plurality of metal members between the first electrode and the second electrode; and embedding the rivet into the metal member by pressurization and energization using the first electrode and the second electrode, wherein the preparing includes preparing, as the first electrode and the second electrode, two electrodes that satisfy a condition in which each of electrical resistance values of the first and second electrodes is lower than or equal to a sum of an electrical resistance value of the plurality of metal members to be joined and an electrical resistance value of the rivet.

According to this embodiment, the electrical resistance value of the entire configuration for joining the rivet and the plurality of metal members in addition to the first and second electrodes can be reduced by restricting the electrical resistance values of the first and second electrodes to lower levels. Thus, the amount of current flowing through the entire configuration can be increased even at the same voltage, compared to when the first and second electrodes do not satisfy the condition in which each of the electrical resistance values of the first and second electrodes is lower than or equal to the sum of the electrical resistance value of the plurality of metal members to be joined and the electrical resistance value of the rivet. This enables a specified high current to flow during pressurization and energization at the time of resistance welding.

(2) In the above embodiment, the first and second electrodes may be formed of a copper alloy containing chromium. According to this embodiment, since the first and second electrodes are formed of a copper alloy that contains chromium, which has a relatively low electrical resistivity, the condition in which the electrical resistance value of the entire configuration for the above joining is reduced can be achieved easily without increasing the size of the equipment configuration.

Reference Signs List

11 . . . Rivet, 12 . . . Aluminum plate (metal member), 13 . . . Iron plate (metal member), 14 . . . First electrode, 15 . . . Second electrode, 16 . . . First shank, 17 . . . Second shank, 18 . . . First electrode portion, 19 . . . Second electrode portion, 21 . . . Head, 22 . . . Shaft part, 23 . . . Laminated body to be welded, P10 . . . Preparation step, P20 . . . Sandwiching step, P30 . . . Embedding step

What is claimed is:

1. A method for joining different kinds of metal materials, wherein a plurality of metal members made of different materials are joined by resistance welding using a rivet, the method comprising:
preparing the rivet, the plurality of metal members, and a first electrode and a second electrode, each having a shank and an electrode portion provided at a tip of the shank;
sandwiching the rivet and the plurality of metal members between the first electrode and the second electrode; and
embedding the rivet into the metal member by pressurization and energization using the first electrode and the second electrode, wherein
the preparing includes preparing, as the first electrode and the second electrode, two electrodes that satisfy a condition in which each of electrical resistance values of the first and second electrodes is lower than or equal to a sum of an electrical resistance value of the plurality of metal members to be joined and an electrical resistance value of the rivet.

2. The method for joining different kinds of metal materials according to claim 1, wherein the first and second electrodes are formed of a copper alloy containing chromium.
